(19) United States
(12) Patent Application Publication
(10) Pub. No.: US 2025/0328946 A1
(43) Pub. Date: Oct. 23, 2025

(54) NATURAL LANGUAGE PROCESSING-BASED PRODUCT RECOMMENDATION SYSTEM AND METHOD ENABLING PROVISION OF PRODUCT PLANNING INFORMATION

(71) Applicant: HAREX INFOTECH INC., Seoul (KR)

(72) Inventors: Kyung Yang PARK, Seoul (KR); Kyoung Jun LEE, Seoul (KR)

(73) Assignee: HAREX INFOTECH INC., Seoul (KR)

(21) Appl. No.: 18/864,599

(22) PCT Filed: May 2, 2023
(86) PCT No.: PCT/KR2023/005944

§ 371 Date: Nov. 11, 2024

(30) Foreign Application Priority Data
May 11, 2022 (KR) 10-2022-0057681
Nov. 7, 2022 (KR) 10-2022-0146782

(51) Int. Cl. G06Q 30/0601

(52) U.S. Cl. CPC G06Q 30/0631

(57) ABSTRACT

A natural language processing-based product recommendation system enabling provision of product planning information is provided. The system includes: an input unit for collecting purchase information for each user; a memory in which a program for generating recommendation product information and product planning information for a target customer on the basis of the purchase information of a user is stored; and a processor for executing the program stored in the memory, wherein the processor tokenizes multiple product names corresponding to products included in the purchase information to segmenting same in units of tokens, and generates and provides, as the product planning information, a result obtained by combining multiple units of tokens with each other.

### FIELD OF THE INVENTION

The present disclosure relates to a natural language processing-based product recommendation system and method enabling provision of product planning information.

### BACKGROUND ART

Many merchant owners, companies, etc. (hereinafter, business operators) are introducing product recommendation systems that appropriately suggest products that users are likely to purchase by identifying their purchasing tendencies.

Therefore, much research is being conducted on product recommendation systems, and in particular, research on a natural language processing-based product recommendation system using a product name is receiving attention.

Meanwhile, conventional product recommendation systems learn all product names in many cases, and as a result, there is a limitation that only limited products can be recommended to users.

In addition, the conventional product recommendation systems perform learning by simply removing data not matching correct data during the learning process or processing the above data as an incorrect answer, and thus there is a problem that data generated during a middle process cannot be properly used.

### DETAILED DESCRIPTION OF THE INVENTION

### Problem to be Solved

The present disclosure is directed to providing a natural language processing-based product recommendation system and method enabling the provision of product planning information, which are capable of recommending relevant products to target customers through a natural language processing-based product recommendation service and providing a business operator with new product names resulting from a new token combination not included in correct answer data during a product recommendation process as product planning information.

However, the objects of the present disclosure are not limited to the above object and other objects may be present.

### Technical Means to Solve the Problem

To achieve the above object, a natural language processing-based product recommendation system enabling provision of product planning information according to a first aspect of the present disclosure includes an input unit configured to collect user-specific purchase information, a memory configured to store a program for generating recommended product information and product planning information for a target customer based on the user-specific purchase information, and a processor configured to execute a program stored in the memory, wherein the processor tokenizes a plurality of product names corresponding to products included in the purchase information to segmenting the tokenized product names into token units and generate and provide the result of combining the plurality of token units as the product planning information. In this case, the processor tokenizes a plurality of product names corresponding to products included in the purchase information to segmenting the tokenized product names into token units and generate and provide the result of combining the plurality of token units as the product planning information.

In addition, a method performed by a natural language processing-based product recommendation system enabling provision of product planning information according to a second aspect of the present disclosure includes collecting pieces of purchase information according to completed purchase at a plurality of merchants, tokenizing a plurality of product names corresponding to products included in the purchase information and segmenting the product names into token units, generating product recommendation information for a target customer based on the result of combining the plurality of token units, and generating the result of combining the plurality of token units as the product planning information.

To achieve the above object, a computer program according to another aspect of the present disclosure is coupled to a computer that is hardware to execute a program for the user-centric hyper-personalized product recommendation and marketing method and stored in a computer readable storage medium.

Other detailed matters of the present disclosure are included in a detailed description and drawings.

### Effect of the Invention

According to the present disclosure, the natural language processing-based product recommendation system can be used to recommend the relevant product, and at the same time, new product planning ideas can be derived.

That is, while the conventional product recommendation systems can only perform one task using one model, one embodiment of the present disclosure has an advantage that a structure that can be used for any task using only one model is provided.

Therefore, one embodiment of the present disclosure can contribute to the actual launch of new products through big data analysis such as frequency analysis or summary analysis in the future.

The effects of the present disclosure are not limited to the above-described effects, and other effects that are not described will be able to be clearly understood by those skilled in the art from the following description.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a view for describing a concept that generates product planning information in one embodiment of the present disclosure;

FIG. 2 is a block diagram of a natural language processing-based product recommendation system enabling the provision of product planning information according to one embodiment of the present disclosure;

FIG. 3 is a view showing an example of tokenizing products name included in purchase information;

FIG. 4 is a view showing an example of learning data and recommendation result values of a product recommendation artificial intelligence algorithm;

FIG. 5 is a view for describing a content provided as recommended product information for a product name not included in correct answer data;

FIG. 6 is a flowchart of a method performed by the natural language processing-based product recommendation system enabling product planning information according to one embodiment of the present disclosure;

FIG. 7 is a view showing a payment model according to the related art and a user-centric payment model according to one embodiment of the present disclosure;

FIG. 8 is a view showing an artificial intelligence model according to the related art and an artificial intelligence model according to one embodiment of the present disclosure;

FIG. 9 is a view showing a product recommendation service providing server using purchase item information according to one embodiment of the present disclosure;

FIG. 10 is a view showing a single merchant and users according to the related art;

FIG. 11 is a view showing a multi-merchant and users according to one embodiment of the present disclosure;

FIG. 12 is a view showing a user-centric artificial intelligence structure according to one embodiment of the present disclosure;

FIG. 13 is a view showing a product recommendation service scenario based on the user-centric artificial intelligence structure according to one embodiment of the present disclosure;

FIG. 14 is a view showing a recommendation service provision using payment data (purchase information) according to one embodiment of the present disclosure;

FIGS. 15 and 16 are views showing performance comparison results of recommendation algorithms according to one embodiment of the present disclosure;

FIG. 17 is a view showing performance results of a matrix-based ECF (M-ECF) according to one embodiment of the present disclosure;

FIG. 18 is a view showing performance results of a vector-based ECF (V-ECF) according to one embodiment of the present disclosure;

FIG. 19 is a view showing preprocessing completion data according to one embodiment of the present disclosure;

FIG. 20 is a view showing product-to-vector (Product2vec) and user propensity vector generation according to one embodiment of the present disclosure;

FIG. 21 is a view showing product recommendation results according to one embodiment of the present disclosure;

FIG. 22 is a view showing a recommendation evaluation scenario according to one embodiment of the present disclosure; and

FIG. 23 is a view showing a product recommendation service providing method using purchase item information according to one embodiment of the present disclosure.

### DETAILED DESCRIPTION OF EXEMPLARY EMBODIMENTS

Advantages and features of the present disclosure and methods for achieving them will become clear with reference to embodiments described below in detail together with the accompanying drawings. However, the present disclosure is not limited to the embodiments disclosed below but may be implemented in various different forms, these embodiments are merely provided to make the disclosure of the present disclosure complete and fully inform those skilled in the art to which the present disclosure pertains of the scope of the present disclosure, and the present disclosure is only defined by the scope of the appended claims.

Terms used in the specification are for describing the embodiments and are not intended to limit the present disclosure. In the present specification, the singular form also includes the plural form unless specifically stated in the phrase. As used herein, “comprises” and/or “comprising” do not preclude the presence or addition of one or more other components other than the stated component. The same reference numerals denote the same components throughout the specification, and the term “and/or” includes each of the stated components and one or more combinations thereof. Although terms such as “first” and “second” are used to describe various components, it goes without saying that the components are not limited by these terms. The terms are only used to distinguish one component from another. Therefore, it goes without saying that a first component described below may be a second component within the technical spirit of the present disclosure.

Unless otherwise defined, all terms (including technical and scientific terms) used in the present specification may be used as meaning commonly understood by those skilled in the art to which the present disclosure pertains. In addition, terms defined in commonly used dictionaries are not construed ideally or excessively unless clearly and specially defined.

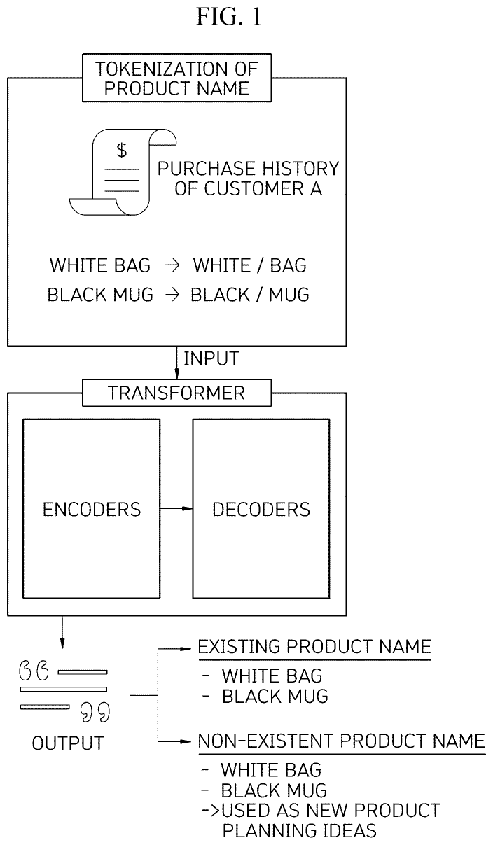

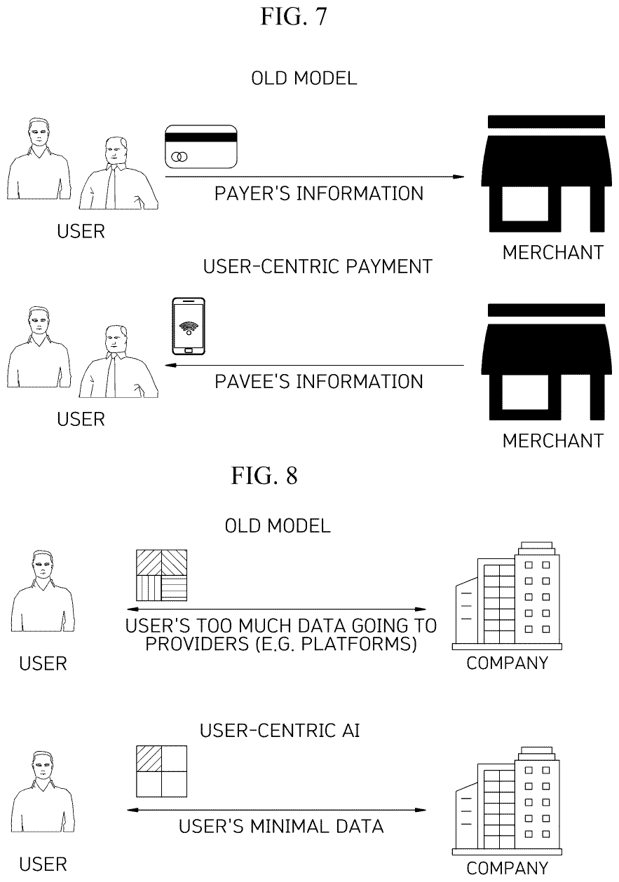

Hereinafter, a natural language processing-based product recommendation system 100 (hereinafter referred to as a system) and method enabling the provision of product planning information according to one embodiment of the present disclosure will be described with reference to FIGS. 1 to 6. In addition, an embodiment of a product recommendation service providing server 200 and method applicable to FIGS. 1 to 5 will be described with reference to FIGS. 7 to 23. Meanwhile, a product recommendation service applicable to the system 100 and method according to one embodiment of the present disclosure is not necessarily limited to a server 200 and method described in drawings after FIG. 7, and it goes without saying that any applicable product recommendation method may be applied.

FIG. 1 is a view for describing a concept that generates product planning information in one embodiment of the present disclosure.

When the system 100 according to the present disclosure acquires product names through a user's purchase information, the system 100 classifies a plurality of product names into token units and inputs the classified product names into a product recommendation artificial intelligence algorithm trained based on the tokens.

As a result of the input, product names that match currently existing product names are provided to users as recommended product information, and when product names that does not match the currently existing product names are output, the product names are provided to business operators as product planning information.

In the example of FIG. 1, when product names “White Bag” and “Black Mug” are each acquired from purchase information of “Customer A,” the product names are each tokenized as “White,” “Bag,” “Black,” and “Mug.” In addition, among results output by inputting each token into the product recommendation artificial intelligence algorithm, “White Bag” and “Black Mug” may be provided to “Customer A” or other user B who satisfies predetermined requirements as recommended product information, and the product names “White Mug” and “Black Bag” may be provided to the business operator as product planning information.

Unlike the conventional learning methods of learning a product as a single product name, the method according to the present disclosure uses a method of learning a product name in segmented token units. As a result, one embodiment of the present disclosure has an advantage that product names that are not present in data can be derived and the derived product names can be used as ideas for developing new products.

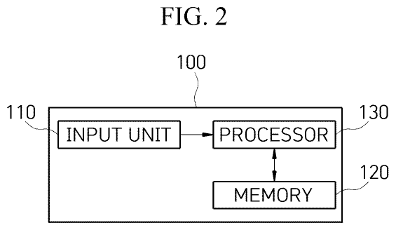

FIG. 2 is a block diagram of the natural language processing-based product recommendation system 100 enabling the provision of product planning information according to one embodiment of the present disclosure.

The system 100 according to one embodiment of the present disclosure includes an input unit 110, a memory 120, and a processor 130.

The input unit 110 collects user-specific purchase information. Here, the user-specific purchase information includes information about a purchase product, a purchase store, a purchase time, and a purchase location.

The memory 120 stores a program for generating recommended product information and product planning information for target customers based on user-specific purchase information.

The processor 130 generates a list of a user-specific recommended products based on the recommended product information for target customers by executing the program stored in memory 120. In addition, the processor 130 generates product planning information for business operators. To this end, the processor 130 tokenizes a plurality of product names corresponding to products included in the purchase information to segmenting the tokenized product names into token units and generates product recommendation information and product planning information based on the result of combining the plurality of token units.

Here, the recommended product information may be generated by further reflecting information generated by a product recommendation service providing server 200, and detailed description of the product recommendation service providing server 200 will be described below.

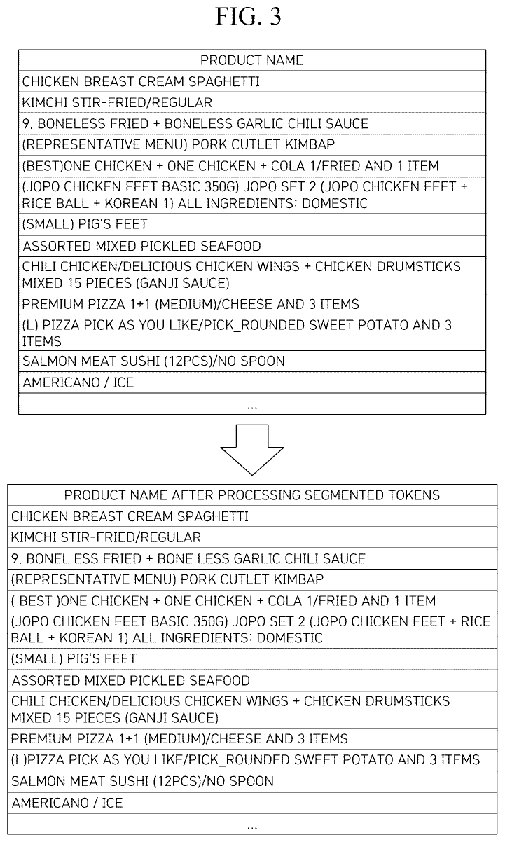

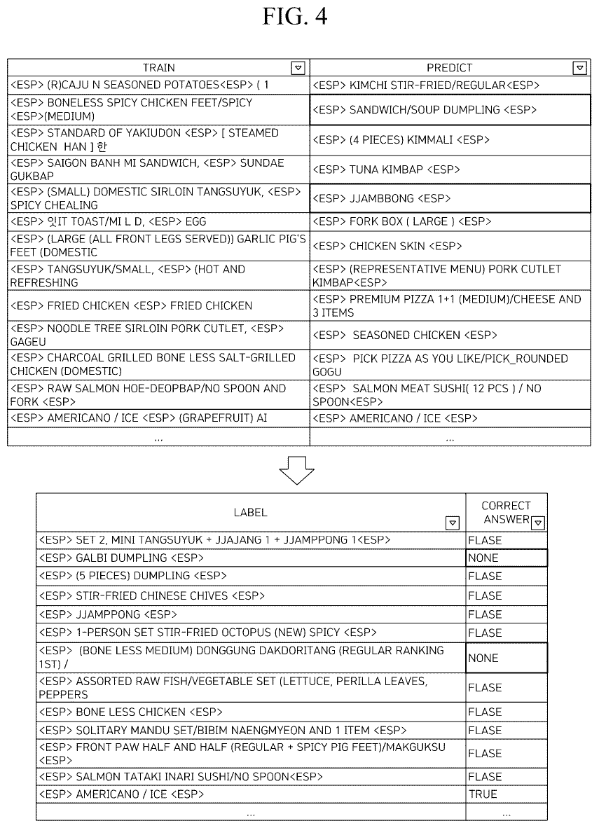

FIG. 3 is a view showing an example of tokenizing products name included in purchase information. FIG. 4 is a view showing an example of training data and recommendation result values of a product recommendation artificial intelligence algorithm.

In one embodiment of the present disclosure, the processor 130 may tokenize a plurality of product names corresponding to products included in purchase information to segmenting the tokenized product names into token units to learn the product recommendation artificial intelligence algorithm and constitute each token segmented into token units as learning data for application.

For example, the processor 130 does not input “chicken breast cream spaghetti” of FIG. 3 into the product recommendation artificial intelligence algorithm as a single product name, but tokenizes the same into segmented tokens such as “chicken breast,” “cream,” and “spaghetti” and inputs the segmented tokens.

In this case, one embodiment of the present disclosure may constitute the learning data as training data according to a predetermined ratio and correct answer data corresponding to the recommended product information. For example, a ratio of the training data and the correct answer data may be 4:1. That is, among five product names “a, b, c, d, and e” acquired from the purchase information, product names “a, b, c, and d” may be formed as training data, and product name “e” may be formed as correct data.

The processor 130 may set the training data formed in this way to be input to an input terminal of the natural language processing-based product recommendation artificial intelligence algorithm and set the correct answer data to an output terminal to learn the product recommendation artificial intelligence algorithm.

Through such learning data, the product recommendation artificial intelligence algorithm is learned to output the product name “e,” which is predicted to be most likely to be purchased by the user, as recommended product information when the product names “a, b, c, and d” are input.

Meanwhile, in one embodiment of the present disclosure, the product recommendation artificial intelligence algorithm may be a TransformRec-based algorithm. The TransformRec uses Transformer among natural language processing models, and unlike the conventional learning methods of performing learning using a single product name, the TransformRec uses a method of learning tokens units into which the product name is segmented.

Referring to FIG. 4, in one embodiment of the present disclosure, the processor 130 provides recommended product information, which is a predicted value output from the output terminal through learning of the product recommendation artificial intelligence algorithm.

The processor 130 may output recommended product information, which is an output value of the product recommendation artificial intelligence algorithm, as a combination of token units, and some product names in which tokens are combined may be derived as non-existent products.

For example, when a certain user purchases “chicken breast cream spaghetti,” “octopus bibimbap,” “pork rice bowl,” and “ham and cheese toast,” these are learned as detailed token units of “chicken breast,” “cream,” “spaghetti,” “octopus,” “bibimbap,” “pork,” “rice bowl,” “ham and cheese,” and “toast.” Calculated values are also derived in token units and may be derived as a new product such as “octopus cream spaghetti” or “pork toast,” which is not an actual product.

In one embodiment of the present disclosure, when combing tokens based on training data, the processor 130 may combine a first token and a second token for only a product name of a first product or combine the first token and the second token for only a product name of a second product to generate recommended product information and product planning information. Alternatively, the recommended product information and the product planning information may be generated by combining the first token of the product name of the first product and the second token of the product name of the second product.

According to the result of testing the product recommendation artificial intelligence algorithm according to the present disclosure, it was confirmed that cases that are not actually sold account for about 12% of the total learning results. Non-existent products derived in this way, that is, new products, are provided to business operators as product planning information to be used as ideas for developing new products.

To this end, the processor 130 compares the recommended product information, which is a predicted value output from the output terminal through the learning of the product recommendation artificial intelligence algorithm, with the corresponding correct answer data. In addition, the processor 130 may set the correct answer according to the result of the comparison to re-learn the product recommendation AI algorithm, but when the recommended product information, which is the predicted value, is a product name (NONE) not included in the correct answer data, the processor 130 may generate and provide the corresponding product name as product planning information.

In one embodiment of the present disclosure, the processor 130 may learn the product recommendation artificial intelligence algorithm repeatedly a preset number of times. For example, when the preset number of times is 100, a plurality of recommended product information and product planning information corresponding to 100 times may be derived through the 100-time learning process.

In this case, the processor 130 may tokenize product planning information (first product planning information) output through the preset number of times to constitute the product planning information as learning data and further generate and provide second product planning information output by being input into the product recommendation artificial intelligence algorithm. That is, one embodiment of the present disclosure has an advantage that not only the first product planning information determined to be not present is simply provided to the business operator, but also the first product planning information is additionally input into the product recommendation artificial intelligence algorithm to newly generate the second product planning information, thereby deriving and provide more diverse non-existent product names as new product planning ideas.

Furthermore, according to one embodiment of the present disclosure, the product planning information provided by being output through the product recommendation artificial intelligence algorithm is not simply provided to business operators, but may be provided to the business operators based on reliability.

For example, the processor 130 calculates the maximum similarity between the product planning information output as a combination of token units and the corresponding correct answer data. In this case, since a plurality of data with similar product names may be present in the correct answer data, the maximum similarity may be used.

Next, the processor 130 may sort the product planning information in order of lower maximum similarity, assign higher reliability to the lowest maximum similarity, segments the reliability into predetermined grade sections to distinguish the product planning information.

For example, a case of an upper reliability section that is a section with the highest reliability may be a case in which two or more tokens are inconsistent with the correct data, a case of a middle reliability section may be a case in which one token is inconsistent with the correct data, and a lower reliability section may be a case in which only a simple numerical error or typo is present.

In this way, when product planning information is segmented according to reliability, the processor 130 may tokenize only product planning information (first product planning information) corresponding to the upper reliability section, input the tokenized product planning information into the product recommendation artificial intelligence algorithm, and then provide the output second product planning information to business operators.

In this case, according to one embodiment of the present disclosure, a threshold value may be set to a ratio of the product planning information to the total learning data rather than the maximum similarity, and the product planning information may be segmented into a plurality of sections according to the set threshold value.

For example, the processor 130 calculates each of a correct answer rate, incorrect answer rate, and a ratio provided as product planning information of the recommended product information among the output values output through the preset number of times. In addition, the processor 130 calculates each of a correct answer rate, incorrect answer rate, and a ratio provided as product planning information of the recommended product information among output values output once or per a predetermined unit. Then, the processor 130 may set the ratio of product planning information according to the total number of times as a threshold value and segmenting a plurality of grade sections based on the threshold value to assign product planning information.

For example, when the ratio according to the threshold value is 50%, a predetermined range from 50% may be set to a second section, and upper and lower sections of the second section may be set to first and third sections.

In this way, when product planning information is segmented according to the threshold value, the processor may tokenize only product planning information (first product planning information) corresponding to the first section in which the product planning information is most derived and assigned, input the tokenized product planning information into the product recommendation artificial intelligence algorithm, and then provide the output second product planning information to business operators.

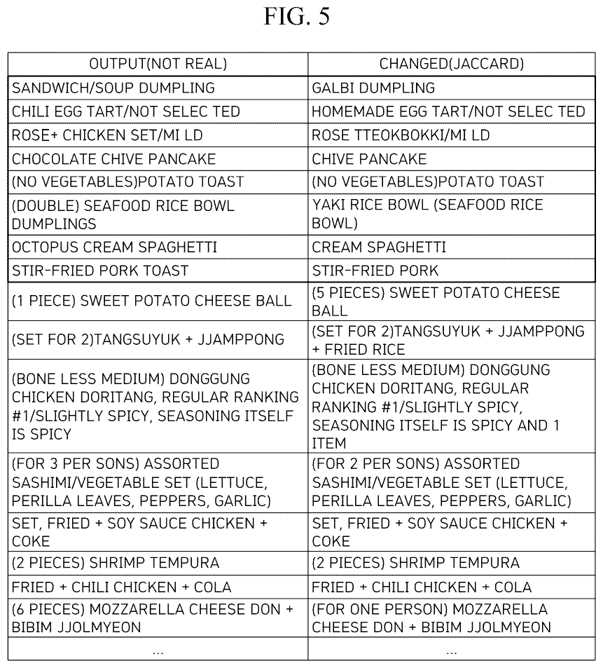

FIG. 5 is a view for describing a content provided as recommended product information for a product name not included in correct answer data.

In a case in which product names that are not actually present are derived, the product names may be provided to the business operators as product planning information, but should not be provided to the user, that is, the customer, as recommended product information.

Therefore, when the recommended product information, which is the predicted value in the product recommendation artificial intelligence algorithm, is a product name not included in the correct answer data, the processor 130 may generate a product name of the correct answer data that satisfies the predicted value and the preset similarity range as recommended product information and provide the generated product name to the user.

In this case, the similarity in one embodiment of the present disclosure may be Jaccard similarity.

In a first row of the table shown in FIG. 5, “Gukmul Mandu” is output as a product name not included in correct answer data, and “Gukmul Mandu” is a non-existent product name and thus cannot be provided as recommended product information to the user. Therefore, the processor 130 may generate “Galbi Mandu” that is a product name that satisfies a preset similarity range as recommended product information and provide the product name to the user.

In addition, the processor 130 may correct the simple inconsistency of product names, such as quantity and missing part of the product name, based on the correct answer data and provide the corrected product name to the user.

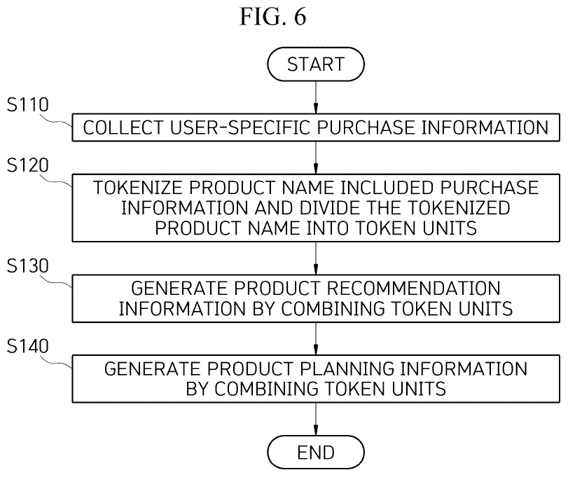

FIG. 6 is a flowchart of a method performed by the natural language processing-based product recommendation system 100 enabling product planning information according to one embodiment of the present disclosure. Meanwhile, it can be understood that operations shown in FIG. 6 are performed by the system 100 described in FIGS. 1 to 5, but the present disclosure is not necessarily limited thereto.

First, the system 100 collects purchase information according to completed purchases at a plurality of merchants (S110).

Next, the system 100 tokenizes a plurality of product names corresponding to products included in the purchase information and segments the product names into token units (S120).

Next, the system 100 generates product recommendation information for target customers based on the result of combining the plurality of token units (S130) and generates the result of combining the plurality of token units as product planning information (S140).

Meanwhile, in the above description, the operations S110 to S140 may be subdivided into a larger number of operations or combined into a smaller number of operations according to embodiments of the present disclosure. In addition, some operations may be omitted as needed, or the order between the operations may be changed. Meanwhile, even when other omitted contents are present, the contents of FIGS. 1 to 5 are also applied to the natural language processing-based product recommendation method enabling the provision of product planning information of FIG. 6.

According to the above-described one embodiment of the present disclosure, the natural language processing-based product recommendation system 100 can be used to recommend the relevant product to the user, and at the same time, new product planning ideas can be derived. That is, while the conventional product recommendation systems can only perform one task using one model, one embodiment of the present disclosure has an advantage that a structure that can be used for any task using only one model is provided. Therefore, one embodiment of the present disclosure can contribute to the actual launch of new products through big data analysis such as frequency analysis or summary analysis in the future.

Hereinafter, the product recommendation service providing server 200 and method for the natural language processing-based product recommendation system 100 and method enabling the provision of product planning information according to one embodiment of the present disclosure will be described in detail with reference to FIGS. 7 to 23.

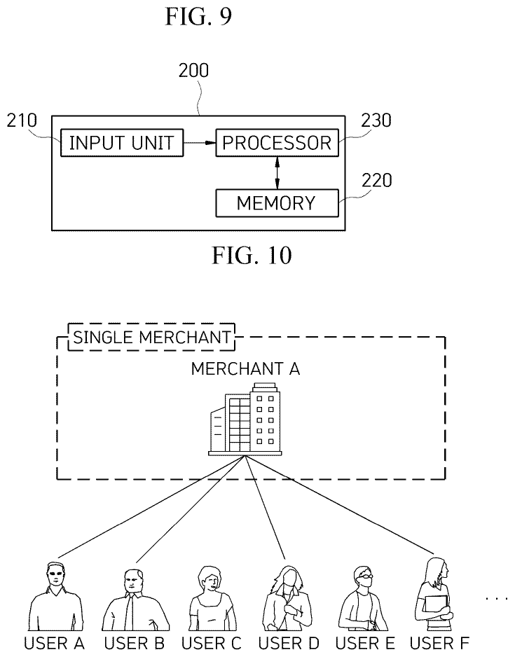

Meanwhile, In one embodiment of the present disclosure, the natural language processing-based product recommendation system 100 enabling the provision of product planning information described in FIG. 2 and the product recommendation service providing server 200 described in FIG. 9 are described as being configured as the independent system 100 or server 200, but are not necessarily limited thereto. That is, it goes without saying that the system 100 and the server 200 may be the same object or implement in any form according to an operator, such as being operated in a form in which an independent program is installed on a single server system.

Hereinafter, for better understanding of those skilled in the art, the background of the proposed present disclosure will be described first, and then one embodiment of the present disclosure will be described.

In order for an artificial intelligence (AI) system to exhibit good performance, learning through a large amount of data is essentially required.

Many companies providing AI services transfer important personal information, such as voice data and text data, to a cloud server to collect a large amount of data, and the data transferred in this way is used to improve the performance of AI models.

For example, in the case of an AI speaker service developed by a domestic company, the task of recording users' conversations and converting the conversations into text is being carried out for the purpose of improving the performance of the AI service.

This is done using the user's voice data to increase a voice recognition rate, and since the task of converting recorded contents into text is handled by a subsidiary, there is a problem that a third-party employee listens to the user's voice data, which poses a serious threat to personal privacy, and similarly, there is a concern about personal information infringement in an AI secretary service.

This is also the case when a product recommendation service is provided to customers using an AI system. That is, when products are recommended using customers' personal information (gender, age, occupation, and the like), there is a problem that personal privacy cannot be preserved in the process of obtaining the customers' user information.

In addition, when a payment service provider wants to recommend products based on customers' payment histories, each merchant defines different product code information, and thus there is a problem of low realism because the code information between merchants needs to be integrated to recommend appropriate products, and furthermore, when a payment service is provided in a global market, there is a problem that it is difficult to provide an appropriate recommendation service in response to environmental factors such as unique products in each country.

Various studies are being conducted to resolve the trade-off relationship between the acquisition of user data and the preservation of personal privacy, and in one embodiment of the present disclosure, an AI service that can achieve intended results while preserving the privacy of personal users and at the same time, enabling the cooperation that maximizes the preservation of information of corporate (organizational) users is defined as a user-centric AI service.

As a specific example of the user-centric AI service according to one embodiment of the present disclosure, there are proposed the server 200 and method, which may provide an appropriate product recommendation service to target customers using purchase information of other customers with high purchase similarity with the target customer without using the customers' personal information.

According to one embodiment of the present disclosure, only the purchase information is used without using the users' personal information, and from the perspective of a single merchant, to supplement insufficient data situations, a product recommendation service is provided using an extrapolative collaborative filtering (ECF) that reflects pieces of purchase information of other merchants and provides recommendations.

Hereinafter, according to the above-described result of the verification, it can be confirmed that appropriate product recommendations are possible without exposing information about personal privacy and information about each merchant using only purchase information maintained for performing the payment service without using personal information.

In addition, as the result of performing verification using the data of the payment service provider according to one embodiment of the present disclosure, it can be confirmed that appropriate recommendations are possible even when purchase information is used in natural language without categorizing product names.

FIG. 7 is a view showing a payment model according to the related art and a user-centric payment model according to one embodiment of the present disclosure.

A payment model in the user-centric AI service according to one embodiment of the present disclosure has main features that a user-centric payment sharing platform-based service is provided and financial information of a paying individual is not transferred to a merchant.

That is, since an ID of a merchant is transferred to a user system of the merchant and a payment service is processed in the user's system (e.g., a smartphone) rather than a structure in which the user's financial information is transferred to the merchant and a system of the merchant is connected to a financial agency as in the related art, the payment may be made without the intervention of an intermediary between the paying user and the financial agency, and thus the user's personal information is not unnecessarily transferred to business operators, but rather pieces of the business operators are accumulated in the user's system, thereby creating the foundation of the user-centric service.

According to the payment model in such a user-centric AI service without the intervention of the intermediary, a fee of a VAN company and a fee of a PG company of the business operators can be reduced, and the risk of leakage of personal information of the customers can be reduced.

In addition, the burden of fees of the business operators can be reduced, and the customers' convenience can be increased as a composite payment capable of processing payment, membership, and the like at once is possible.

FIG. 8 is a view showing an artificial intelligence model according to the related art and an artificial intelligence model according to one embodiment of the present disclosure.

One embodiment of the present disclosure proposes a user-centric AI structure by expanding the payment model in the above-described user-centric AI service.

According to one embodiment of the present disclosure, the user's information is minimally accumulated by companies (only product purchase history information is accumulated to provide a product recommendation service without accumulating personal information, thereby eliminating the possibility of personal privacy infringement), and each company may provide a high-performance AI-based service without directly sharing its customer information with other companies.

That is, as shown in FIG. 8, the AI model structure according to the related art transfers all of the user's data to the company and the company provides a service by advancing the algorithm through the entire data, while the user-centric AI service model structure according to one embodiment of the present disclosure may provide an appropriate service (e.g., a product recommendation service) to the user using only the minimum amount of data.

That is, according to one embodiment of the present disclosure, the privacy of individual users can be preserved, data of business operators (corporate users) can be securely collaborated, and a relevant, novel, and beneficial service can be provided using minimal information.

Business operators (corporate users) may provide a service to individual users without directly sharing data between companies, and general users may receive relevant services while preserving their privacy when receiving the service.

FIG. 9 is a view showing the product recommendation service providing server 200 using purchase item information according to one embodiment of the present disclosure.

According to one embodiment of the present disclosure, for example, when customer A wants to make a purchase at a shopping mall, the shopping mall retrieves customers similar to customer A using only purchase information without using customer A's personal information (gender, age, occupation, and the like) in a process of recommending new items to customer A.

At this time, comprehensively considering products and number of times purchased by customer A, purchase dates and places, and the like, customer B with a similar purchase pattern is retrieved, and products that customer A did not purchase among products that customer B purchased are recommended to customer A.

According to one embodiment of the present disclosure, a recommendation service is provided using only purchase information without using the user's (general user's) personal information through the ECF.

According to one embodiment of the present disclosure, product recommendation information is provided using position information and time information in which a target customer is currently positioned.

For example, in the case of a coffee shop of Company A where the target customer is visiting for the first time, purchase information of other coffee shops (Company B, Company C, and the like) previously visited by the target customer and purchase information of other customers at the other coffee shops are used to consider purchase histories of the other customers similar to the target customer's tendency, thereby recommending products that are expected to have satisfaction to the target customer among coffee shops of Company A.

In addition, in calculating similarity, it is possible to perform tendency identification only for the target customer in consideration of the purchase time information of the target customer.

For example, it is assumed that the target customer has a history of purchasing a cup of iced Americano at a coffee shop during the week while commuting to and from work, and a history of purchasing a cup of iced Americano and a cup of iced green tea latte at a coffee shop with his/her spouse on the weekend.

In that case, it is assumed that iced Americano is a beverage mainly consumed by the target customer, and iced green tea latte is a beverage mainly consumed by companions (e.g., spouse or friends) who are not the target customer.

Therefore, considering the time information (including date) that the target customer currently wants to order, in the case of the weekday, according to the above case, coffees (e.g., iced Americano) may be suggested as a recommended product at a coffee shop of Company A, and in the case of the weekend, recommended products (coffees or iced Americano) may be suggested for the target customer and recommended products (non-coffee type beverages, green tea latte, or sweet potato latte) may be suggested for companions at the coffee shop of Company A.

That is, although purchase information can be seen as including the tendency of the target customer, not all purchased items may be used by the target customer, and thus in a process of retrieving similar customers using purchase history and suggesting recommended products, it is possible to separately suggest recommended products not only for the target customer but also for companions accompanying the target customer comprehensively considering date, time, and location.

The product recommendation service providing server 200 using purchase item information according to one embodiment of the present disclosure includes an input unit 210 for collecting user-specific purchase information, a memory 220 for storing a program that generates recommended product information for a target customer using the user-specific purchase information, and a processor 230 for executing the program. In this case, the processor 230 retrieves other customers of which purchase tendencies are within a preset similarity range with the target customer and generates recommended product information to be recommended to the target customer in consideration of items purchased by the other customers.

Here, the user-specific purchase information includes information about a purchased product, a purchaser, a purchase time, and a purchase location.

The processor 230 retrieves other customers with similar purchase tendency using the ECF algorithm for purchase information from a plurality of merchants.

The processor 230 builds a matrix for user-specific purchase information, retrieves other customers through cosine similarity based on the target customer, and recommends products purchased by the other customers.

The processor 230 detects similarity using vector-based ECF and generates recommended product information.

The processor 230 retrieves other customers with similar purchase tendency by learning the user-specific purchase information as a sentence to obtain a product-to-vector that converts the purchase product history into a vector and generating a user purchase tendency vector by multiplying a product vector.

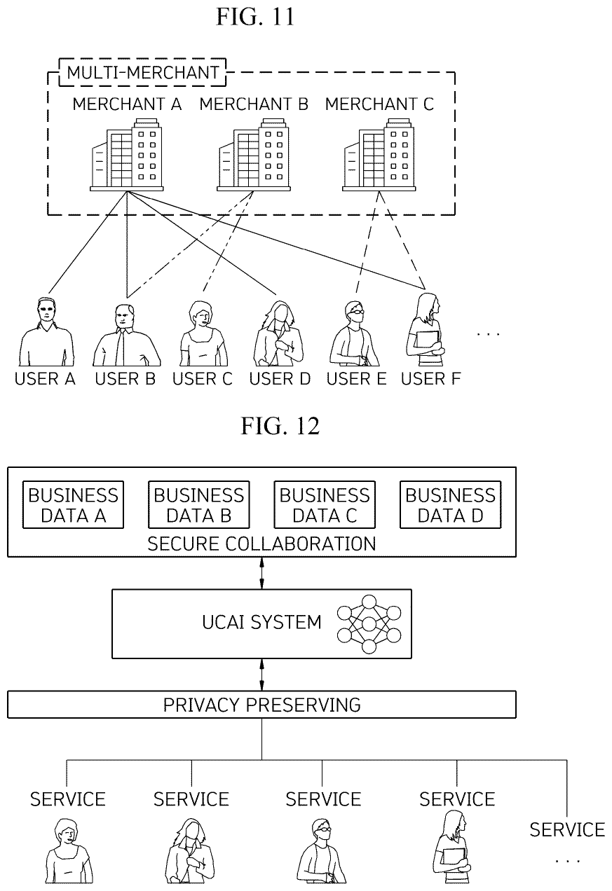

FIG. 10 is a view showing a single merchant and users according to the related art, and FIG. 11 is a view showing a multi-merchant and users according to one embodiment of the present disclosure.

Referring to FIG. 10, in the case of a single merchant, a recommendation service is provided using only the applicant's purchase information, and thus it is difficult to provide an appropriate recommendation service to a user who has visited the applicant for the first time, and to provide a recommendation service, it is necessary to retrieve similar users using the user's personal information and provide a recommendation service using the retrieved user's purchase history.

On the other hand, in the case of a multi-merchant of FIG. 11, even when the user visits the applicant for the first time, from the perspective of the target customer, it is possible to retrieve similar users in other stores without using personal information by reflecting the purchase information of other merchants and provide a recommendation service.

FIG. 12 is a view showing a user-centric artificial intelligence structure according to one embodiment of the present disclosure.

As described above, business data, that is, data of business operators (corporate users), can be securely collaborated, privacy can be preserved using only purchase information without using pieces of personal information of individual users, and the relevant, novel, and beneficial service can be provided.

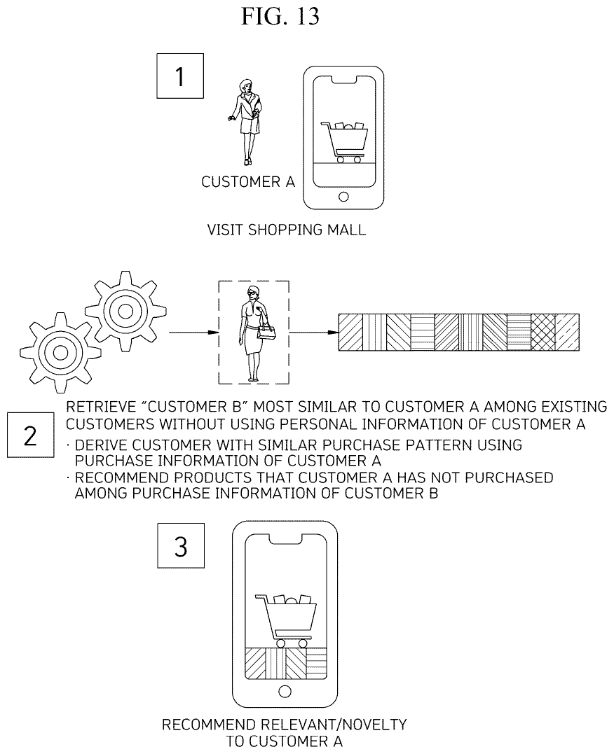

FIG. 13 is a view showing a product recommendation service scenario based on the user-centric artificial intelligence structure according to one embodiment of the present disclosure.

According to one embodiment of the present disclosure, for example, when customer A wants to make a purchase at a shopping mall, the shopping mall retrieves customers similar to customer A using only purchase information without using customer A's personal information (gender, age, occupation, and the like) in a process of recommending new items to customer A.

At this time, comprehensively considering products and number of times purchased by customer A, purchase dates and places, and the like, customer B with a similar purchase pattern is retrieved, and products that customer A did not purchase among products that customer B purchased are recommended to customer A.

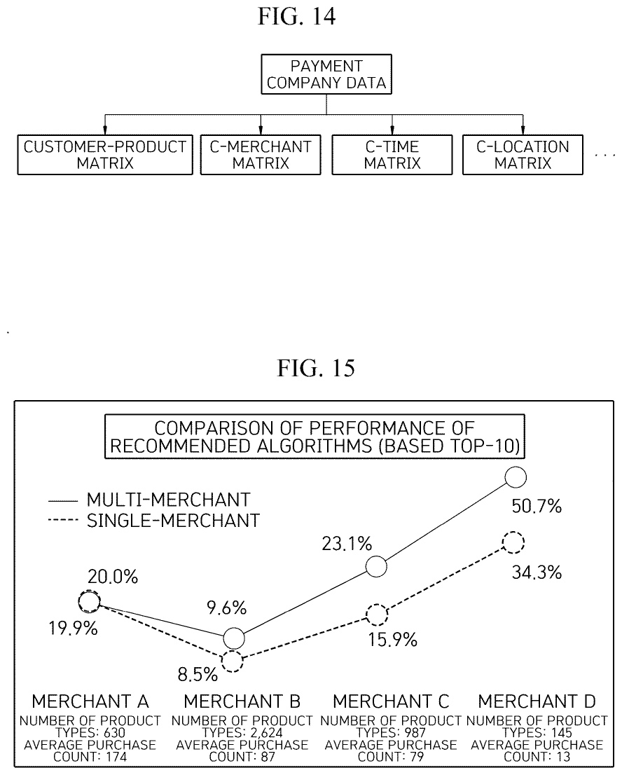

FIG. 14 is a view showing a recommendation service provision using payment data (purchase information) according to one embodiment of the present disclosure.

According to one embodiment of the present disclosure, to preserve the privacy of users (general users), personal information (gender, age, and the like) is not used, and only purchase information is used as minimum information.

The purchase information includes information about a purchased product, a purchaser, a purchase time, and a purchase location, and the purchase information is built in the form of a matrix to retrieve similar users, and a list of recommendations is generated using products purchased by similar users (at this time, the list of the recommendations may include top 5, top 10, and top 20 products).

According to one embodiment of the present disclosure, to supplement the insufficient data situation at a single merchant, a method of making recommendations using purchase information from other merchants is proposed, and to resolve the limitations of the single merchant, such as a new user problem (cold-star) and to analyze merchant preference patterns of users (general users) who use various merchant groups, purchase information is used through the ECF.

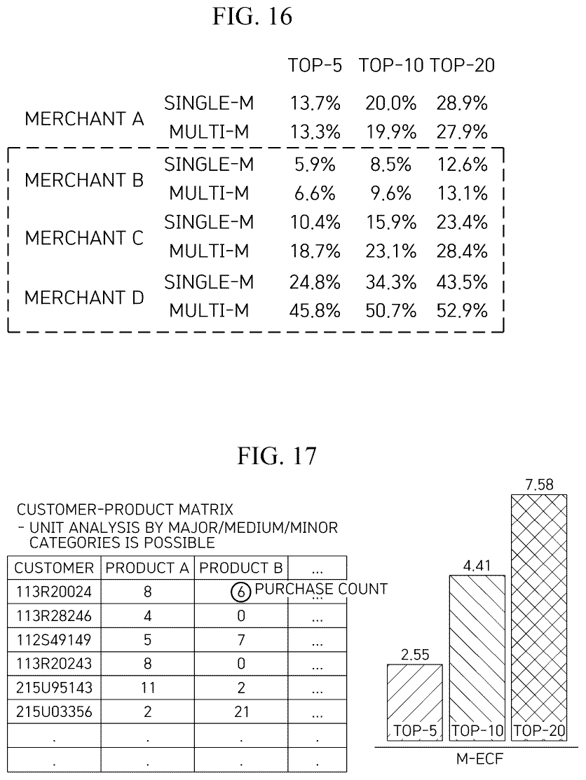

FIGS. 15 and 16 are views showing performance comparison results of recommendation algorithms according to one embodiment of the present disclosure, and FIG. 17 is a view showing performance results of a matrix-based ECF (M-ECF) according to one embodiment of the present disclosure.

From the perspective of a multi-merchant, payment data that may identify purchase information from various merchants was used as experimental data to verify the performance of the above-described ECF algorithm.

From the published raw data, users with various merchant purchase histories were extracted for developing algorithms, and a dataset was built using user-specific purchase information (purchased items, purchase merchants, and purchase time and location), which is essential information for purchase, exchange, and refund, and no other personal information was used.

To verify the performance of the ECF algorithm, it was assumed that there is a standardized category for products handled by each merchant, and recommendation performance was evaluated using the M-ECF (Matrix ECF) implemented based on the standardized code.

Referring to FIG. 17, a user purchase information dataset is built in the form of a matrix in which a standardized product category is one column, and then similar users are retrieved by deriving similarity with other users through cosine similarity based on the user, and products purchased by the similar users are recommended.

A method of evaluating the prediction accuracy of recommended products separates the last product from a list of products purchased by users into a label value in advance and evaluates prediction accuracy by comparing the last product with a finally recommended product, and a method of calculating prediction accuracy is as shown in

$$\begin{matrix}[ Equation 1 ] & \\ Acc = \frac{the number of matched users}{the number of recommended users} \times 100. & [ Equation 1 ]\end{matrix}$$

The ECF algorithm developed through public payment data was applied to actual payment history data to empirically verify whether the ECF algorithm had relevant recommendation results.

FIGS. 15 and 16 show the result of comparing and evaluating a matrix-based ECF algorithm from the perspective of a single merchant and a multi-merchant, and from the perspective of the single merchant, recommendation was made using only the user purchase information of the applicant for each of Merchants A, B, C, and D, and from the perspective of the multi-merchant, recommendation was made to Merchants A, B, C, and D through pieces of purchase information of all users.

As a result, it can be confirmed that there is no significant difference between Merchant A and B with many types of products and a larger amount of pieces of purchase information, while the ECF algorithm shows higher prediction accuracy than the single merchant for Merchant C and D with a smaller amount of pieces of purchase information.

That is, large companies with a large number of pieces of purchase information show sufficient recommendation performance using only the applicant's data, but small and medium-sized companies lack data to make recommendations, and thus as a result of using pieces of purchase information of other merchants, it was confirmed that the ECF algorithm was effective.

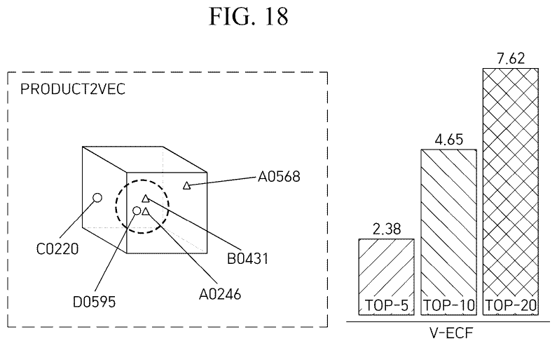

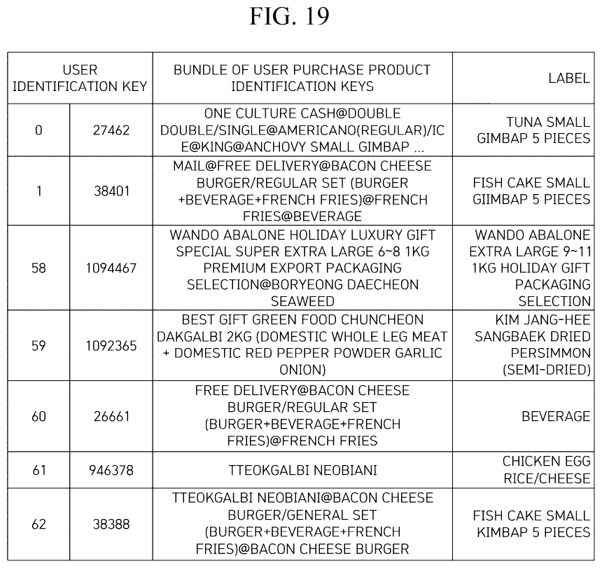

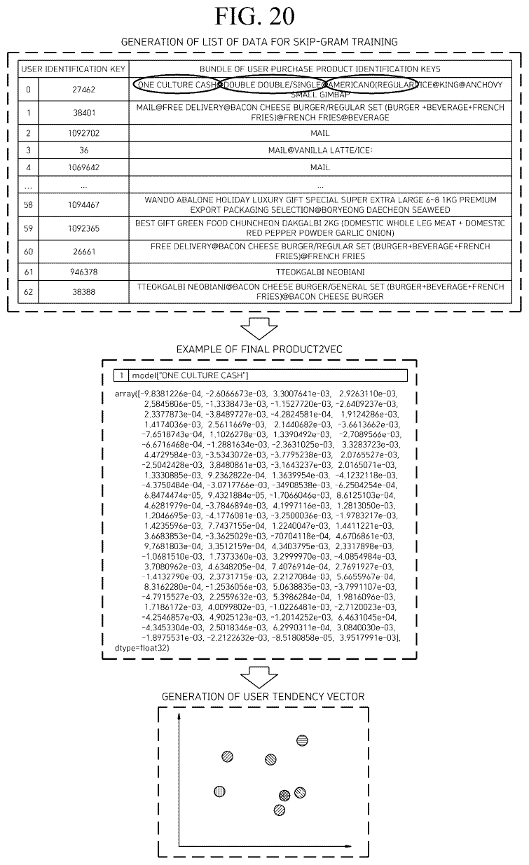

FIG. 18 is a view showing performance results of a V-ECF according to one embodiment of the present disclosure, FIG. 19 is a view showing preprocessing completion data according to one embodiment of the present disclosure, and FIG. 20 is a view showing product-to-vector (Product2vec) and user propensity vector generation according to one embodiment of the present disclosure.

Referring to FIG. 19, excluding empty (NULL) values in the product name (considering all of Product name 1, Product name 2, and Product name 3), products purchased only once are excluded because model learning is not performed properly.

To check the result of the recommendation, the last product is a label value for performance evaluation, and thus the minimum number of purchases needs to be 2 or more.

A list of products (a bundle of user-purchased product identification keys) is generated for each user.

Referring to FIG. 18, the V-ECF is used so that natural language may be used for processing.

According to one embodiment of the present disclosure, a word-to-vector (Word2vec) model is used to set products purchased by a user to words and train the list of purchased products as sentences through a Skip-gram technique.

That is, the actual purchase product history is converted into vectors, which is defined as purchased product to vector (Product2Vec).

The product to vector generated in this way is multiplied by each product vector purchased by the user to generate a user purchase tendency vector, and similar users are retrieved through similarity calculation.

According to one embodiment of the present disclosure, by using a recommendation algorithm in natural language without categorizing the user's product purchase information, it is possible to directly reflect newly appearing products in the recommendation algorithm without a separate classification process.

In addition, from the perspective of the multi-merchant, the process of categorizing product names that do not match each merchant is unnecessary, and furthermore, it is possible to automatically reflect products of global merchants used in different languages in the recommendation algorithm.

Hereinafter, the result of comparing the matrix-based ECF and the vector-based ECF in [Table 1] shows similar recommendation prediction accuracy.

TABLE 1

| Items | M-ECF | V-ECF |
|---|---|---|
| Top-5 | 2.55% | 2.38% |
| Top-10 | 4.41% | 4.65% |
| Top-20 | 7.58% | 7.62% |

Since the vector-based ECF processes product purchase information in natural language without processing, it is possible to reflect the product purchase information in the recommendation algorithm without human determination and intervention.

In addition, as described above, in the case of the multi-merchant in which various products are newly introduced, product names between other merchants do not match, and it can be confirmed that the performance of the vector-based ECF is secured compared to the matrix-based ECF that requires separate processing for product information.

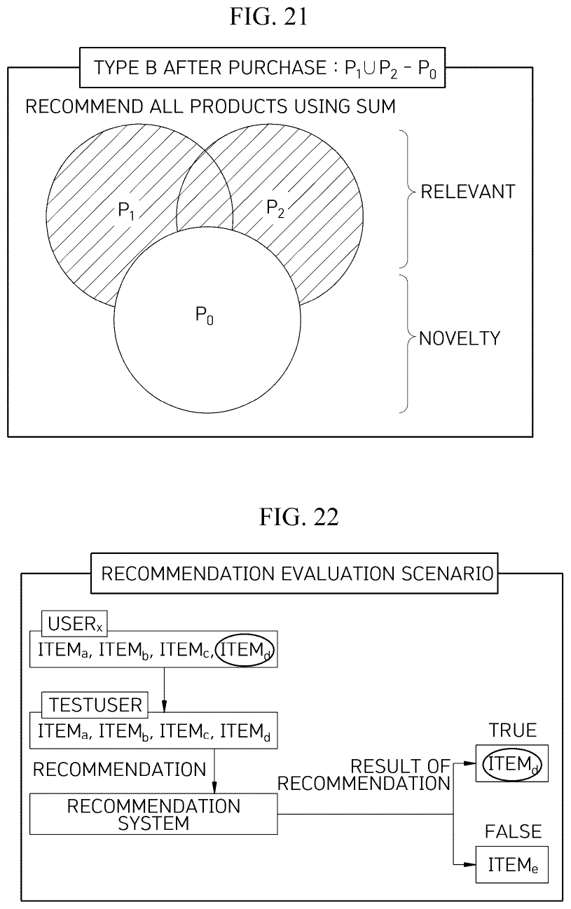

FIG. 21 is a view showing product recommendation results according to one embodiment of the present disclosure.

When P₁ is defined as a product purchased by a similar user, P₂ is defined as a product with high similarity to a product just purchased by a target customer (the above-described customer A), and P₀ is defined as a product purchased by the target customer (the above-described customer A) in the past, the result of subtracting P₀ from the sum of P₁ and P₂ is recommended.

FIG. 22 is a view showing a recommendation evaluation scenario according to one embodiment of the present disclosure.

The number of purchases varies by user, and the last product purchased by the actual user is removed to create a test user, and the user most similar to a new user (target user) is retrieved through similarity calculation.

Excluding common purchase products of users similar to the target user, items most frequently purchased by similar users are recommended as top 5, 10, and 20, and when the target user purchases one of the recommended products, it is considered a relevant recommendation.

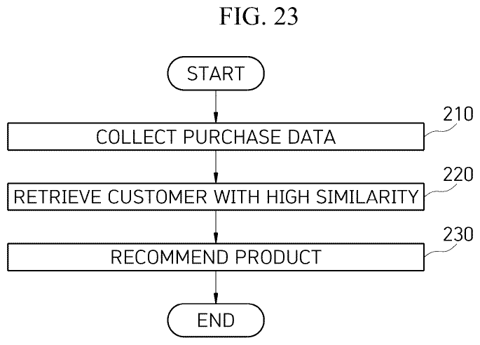

FIG. 23 is a view showing a product recommendation service providing method using purchase item information according to one embodiment of the present disclosure.

A method performed by a product recommendation service providing server 200 using purchase item information according to one embodiment of the present disclosure includes an operation S210 of collecting purchase information according to completed purchases from a plurality of merchants, an operation S220 of retrieving other customers with high similarity in purchase tendency to a target customer using the purchase information, and an operation S230 of recommending products to the target customer using pieces of purchase item information of other customers.

The operation S210 includes collecting purchase data including information about a purchased product, a purchaser, a purchase time, and a purchase location.

The operation S220 includes retrieving other customers using an extrapolation collaborative filtering algorithm.

The operation S220 includes building a matrix for purchase information for each user and retrieving other customers with high similarity in purchase tendency based on the target customer.

The operation S220 includes retrieving other customers using a vector-based extrapolation collaborative filtering algorithm.

The operation S220 includes retrieving other customers by learning purchase information as sentences, obtaining a product-to-vector that converts a purchase product history into a vector, and multiplying the product vector to generate a user purchase tendency vector.

According to the product recommendation service providing server 200 and method according to one embodiment of the present disclosure, it is possible to provide a relevant product recommendation service to the target customer by retrieving customers similar to the target customer among existing customers without using the customer's personal information.

In addition, by collecting only the minimum information about the customer and providing the service, it is possible to preserve the privacy of individual users and provide a relevant, novel, and beneficial service while securely and fairly collaborating between business operators without mutually sharing or integrating the data of users (corporate users).

The above-described one embodiment of the present disclosure may be implemented in the form of a program (or application) to be executed in combination with a computer as hardware and may be stored in a medium.

The above-described program may include codes coded in a computer language, such as C, C++, JAVA, Ruby, or machine language, which can be read by a processor (CPU) of the computer through a device interface of the computer so that the computer reads the program and executes the methods implemented by the program. These codes may include functional codes related to functions that define functions necessary for executing the above-described methods and include control codes related to execution procedures necessary for the processor of the computer to execute the above-described functions according to a predetermined procedure. In addition, these codes may further include memory reference-related codes regarding which location (address) of an internal or external memory of the computer should be referenced for additional information or media necessary for the processor of the computer to execute the above-described functions. In addition, when the processor of the computer needs to communicate with any other computer or server positioned remotely in order to execute the functions, the code may further include communication-related codes regarding how to communicate with any other computer or server positioned remotely using the communication module of the computer, what information or media to send and receive during communication, and the like.

The storage medium is a medium that semi-permanently stores data and may be read by a device rather than a medium that stores data for a short time, such as a register, a cache, or a memory. Specifically, examples of the storage medium include a read-only-memory (ROM), a random access memory (RAM), a CD-ROM, a magnetic tape, a floppy disk, or an optical data storage device, but are not limited thereto. That is, the program may be stored in any storage media on any server that the computer can access or in any storage media on the user's computer. In addition, since the medium may be distributed to a computer system connected to a network, a code that can be read by the computer may be stored in a distributed manner.

The above description of the present disclosure is for illustrative purpose, and those skilled in the art to which the present disclosure pertains will be able to understand that the present disclosure may be easily modified in other specific forms without changing the technical spirit or essential features thereof. Therefore, it should be understood that the above-described embodiments are illustrative and not restrictive in all respects. For example, each component described in a singular form may be implemented separately, and likewise, components described as being implemented separately may also be implemented in a combined form.

The scope of the present disclosure is defined by the appended claims rather than the detailed description, and all changes or modifications derived from the meaning and scope of the claims and equivalent concepts thereof should be construed as being included in the scope of the present disclosure.

1. A natural language processing-based product recommendation system enabling provision of product planning information, the system comprising:
an input unit configured to collect user-specific purchase information;
a memory configured to store a program for generating recommended product information and product planning information for a target customer based on the user-specific purchase information; and
a processor configured to execute a program stored in the memory,
wherein the processor tokenizes a plurality of product names corresponding to products included in the purchase information to segmenting the tokenized product names into token units and generate and provide the result of combining the plurality of token units as the product planning information.

2. The system of claim 1, wherein the processor constitutes each token segmented into the token units as learning data, constitutes each token as training data according to a predetermined ratio and correct answer data corresponding to the recommended product information, sets the training data to be input into an input terminal of a natural language processing-based product recommendation artificial intelligence algorithm, and sets the correct answer data to an output terminal to learn the product recommendation artificial intelligence algorithm.

3. The system of claim 2, wherein the processor compares the recommended product information, which is a predicted value output from the outer terminal, with the corresponding correct answer data through the learning of the product recommendation artificial intelligence algorithm, sets the presence or absence of correct answer according to the result of the comparison to re-learn the product recommendation artificial intelligence algorithm, and when the recommended product information, which is the predicted value, is a product name not included in the correct answer, generates the corresponding product name as the product planning information.

4. The system of claim 3, wherein, when the recommended product information, which is the predicted value, is the product name not included in the correct answer as the result of comparing the recommended product information, which is the predicted value output from the output terminal of the product recommendation artificial intelligence algorithm, with the correct answer, the processor generates a product name of the correct answer having a product name that satisfies the predicted value and a preset similarity range as the recommended product information.

5. The system of claim 1, wherein the processor retrieves other customers of which purchase tendencies are within a preset similarity range with the target customer and generates recommended product information to be recommended to the target customer in consideration of items purchased by the other customers.

6. The system of claim 5, wherein the processor retrieves other customers with preset similarity with the purchase tendency using an extrapolative collaborative filtering algorithm for pieces of the purchase information at a plurality of merchants.

7. The system of claim 6, wherein the processor builds a matrix for the user-specific purchase information, retrieves the other customers through cosine similarity based on the target customer, and generates the recommended product information that recommends products purchased by the other customers.

8. The system of claim 6, wherein the processor detects similarity using vector-based extrapolative collaborative filtering and generates the recommended product information.

9. The system of claim 6, wherein the processor retrieves other customers with similar purchase tendency by training the user-specific purchase information as a sentence to obtain a product-to-vector that converts a purchase product history into a vector and generating a user purchase tendency vector by multiplying a product vector.

10. A natural language processing-based product recommendation method enabling provision of product planning information, the method comprising:
collecting pieces of purchase information according to completed purchase at a plurality of merchants;
tokenizing a plurality of product names corresponding to products included in the purchase information and segmenting the product names into token units;
generating product recommendation information for a target customer based on the result of combining the plurality of token units; and
generating the result of combining the plurality of token units as the product planning information.

11. The method of claim 10, further comprising:
constituting each token segmented into the token units as learning data and constituting each token into training data according to a predetermined ratio and correct answer corresponding to the recommended product information; and
setting the training data to be input into an input terminal a natural language processing-based product recommendation artificial intelligence algorithm and setting the correct answer data to an output terminal to learn the product recommendation artificial intelligence algorithm.

12. The method of claim 11, wherein the generating of the result of combining the plurality of token units as the product planning information includes:
comparing the recommended product information, which is a predicted value output from the output terminal through the learning of the product recommendation artificial intelligence algorithm, with the corresponding correct answer data;
setting the presence or absence of the correct answer according to the result of the comparison to re-learn the product recommendation artificial intelligence algorithm; and
generating the corresponding product name as the product planning information when the recommended product information, which is the predicted value, is a product name not included in the correct data.

13. The method of claim 12, wherein the generating of the corresponding product name as the product planning information when the recommended product information, which is the predicted value, is a product name not included in the correct answer data includes generating a product name of the correct answer having a product name that satisfies the predicted value and a preset similarity range as the recommended product information.
